(19) United States
(12) Patent Application Publication
(10) Pub. No.: US 2023/0294021 A1
(43) Pub. Date: Sep. 21, 2023

(54) VARIABLE PATHLENGTH UV SPECTROSCOPY BASED AUTOMATED TFF SYSTEM

(71) Applicant: Repligen Corporation, Waltham, MA (US)

(72) Inventors: Ramsey Shanbaky, San Mateo, CA (US); Dodd Weisenberger, Hillsborough, NJ (US); Derek Carroll, Los Angeles, CA (US); Paul Lalo, Succasunna, NJ (US); Brandon Goldberg, Dayton, NJ (US)

(73) Assignee: Repligen Corporation, Waltham, MA (US)

(21) Appl. No.: 18/123,917

(22) Filed: Mar. 20, 2023

Related U.S. Application Data
(60) Provisional application No. 63/321,843, filed on Mar. 21, 2022.

(51) Int. Cl. B01D 29/90; G01N 15/06

(52) U.S. Cl. CPC B01D 29/908; G01N 15/06; G01N 21/33

(57) ABSTRACT

A system for TFF filtration of a feedstock includes a feed vessel containing a solution comprising a target biomolecule, a filter membrane for filtering the solution, a feed pump for moving the solution from the feed vessel to the filter membrane, a buffer vessel coupled to the feed vessel by a buffer supply line, and a diafiltration pump disposed in the buffer supply line for delivering a buffer solution to the feed vessel. A variable path-length instrument is coupled to the feed line for determining, in real time, a concentration of the target biomolecule in the solution. A controller is coupled to the variable path-length instrument, the feed pump, and the diafiltration pump to control operation of the system based on the received information.

### CROSS-REFERENCE TO RELATED APPLICATIONS

This is a non-provisional of pending provisional patent application Ser. No. 63/321,843, filed Mar. 21, 2022, the entirety of which application is incorporated by reference herein.

### BACKGROUND OF THE DISCLOSURE

### Field of the Disclosure

Embodiments of the disclosure relate generally to filtration systems, and more particularly to an improved arrangement using variable pathlength spectroscopy for controlling tangential flow filtration (TFF) systems.

### Discussion of Related Art

Tangential flow filtration (TFF) processes are often utilized in production of therapeutic proteins in the purification and formulation stages to concentrate the target protein and to perform buffer exchanges in a diafiltration process. It is a common practice in production of therapeutic proteins to use a mass calculation process to confirm that protein concentration meets targeted specification values at each point in the diafiltration process. Mass calculation employs a measure of the initial concentration and determines how much fluid to remove from the feed to obtain a “target” concentration.

A common TFF application is a 3-step process for therapeutic protein concentration and buffer exchange. This consists of an initial concentration of the target protein down to a concentration factor based on the initial volume compared to the concentration volume, a diafiltration buffer exchange where a prescribed number of diavolumes of buffer are added to the feed stream to maintain constant concentration and replace the feed stock permeating through the filter, and a final concentration step of the target protein to the desired concentration factor.

Such processes when driven by mass calculation and are subject to error due to process variability. In addition, at high culture concentrations, minimum mixing times in the fluid vessel (e.g., 15 minutes or more) are often required prior to sampling. Continuous mixing during sample analysis involves the potential for degradation of the sample (e.g., drug substance, purified protein, biologic, or the like). In addition, if the measured concentrations are out of specification, additional processing can further degrade the sample. Such systems also require in person monitoring at all steps.

Traditional UV spectroscopy utilizes a cell with a fixed path length between an emitter and a detector to monitor concentration of a fluid sample within the cell. According to the Beer-Lambert law, however, a cell with such a fixed path length will only be able to give information about concentration within a certain range where the relationship between light absorbance and concentration is linear. Outside of this range the sample must be diluted to ensure the concentration falls within the linear range at the time of measurement. The measured value must then be adjusted by the dilution factor to determine the concentration of the undiluted sample.

Traditional UV spectroscopy can be used to monitor concentration of biomolecules in TFF processes. With traditional UV spectroscopic techniques, however, samples must be taken throughout the process duration, and each sample must go through an associated dilution, measurement, and adjustment of the process fluid using the dilution factor. At each measurement the filtration process must be placed on hold by closing off the permeate and recirculating the feed stream.

It would be desirable to improve TFF process automation by using real time in-line concentration measurements of samples instead of mass calculation and traditional fixed path length UV spectroscopy.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Variable path length in-line UV spectroscopy enables monitoring of a wide variety of sample concentrations by dynamically adjusting the path length between the emitter and detector to adjust the concentration range in which there is a linear relationship between light absorbance and concentration. This capability eliminates the need for sample dilution, which is especially useful for taking in-line measurements. An example of such a variable path-length system is the C Tech FlowVPX System offered by Repligen Corporation.

The present disclosure provides an exemplary TFF automation control system and method that utilizes in-line concentration measurement using variable path length spectroscopy to streamline TFF processes and to achieve greater process control and accuracy. By using variable path length in-line UV spectroscopy, real time in line measurement can be taken irrespective of sample concentration. This allows for an uninterrupted process with real time monitoring of protein concentration throughout the run. In some embodiments the system and methods may provide alerts to a user if concentration measurements by the variable path length spectroscopy instrument fall out of desired range.

A system is disclosed for filtration of a feedstock. The system includes a feed vessel containing a solution comprising a target biomolecule; a filter membrane coupled to the feed vessel via a feed line for receiving said solution and filtering said solution, the filter membrane further coupled to the feed vessel via a retentate line for returning filtered solution to the feed vessel; a feed pump for moving the solution from the feed vessel to the filter membrane; a permeate line coupled to the filter membrane, the permeate line for delivering permeate from the filter membrane to a permeate vessel; a variable path-length instrument coupled to at least one of the feed line and the retentate line, the variable path-length instrument configured to transmit light through said solution in the feed line and to correlate, in realtime, the transmitted light with a concentration of the target biomolecule in the solution; and a controller coupled to the variable path-length instrument and the feed pump to receive information therefrom and to execute instructions for controlling operation of at least one of the feed pump, the diafiltration pump, and the variable path-length instrument based on said received information.

In some embodiments the controller is programmed to execute instructions for adjusting a speed of at least one of the diafiltration pump, to maintain the concentration of the target biomolecule in the solution within a predetermined range. In some embodiments the controller is programmed to execute instructions for adjusting a speed of the diafiltration pump during a diafiltration step, to maintain the concentration of the target biomolecule in the solution within a predetermined range. In some embodiments the controller is programmed to execute instructions for receiving, from a user, input values for target concentration and/or diafiltration volume for the system to perform a combination of concentration and diafiltration steps.

In some embodiments the controller is programmed to execute instructions for periodically determining, based on information received from the variable path-length instrument, whether the concentration of the target biomolecule is within a predetermined range of the user input concentration. In some embodiments the controller is programmed to execute instructions for periodically determining, based on information received from the variable path-length instrument, whether the concentration of the target biomolecule is equal to the user input final concentration.

In some embodiments the filter membrane is a tangential flow filtration (TFF) membrane. In some embodiments the TFF membrane is a TFF hollow fiber filter membrane or a TFF cassette membrane.

In some embodiments the controller is configured to provide a user-alert if the concentration of the target biomolecule in the solution is determined, based on information provided by the variable path-length instrument, to have departed from a user-specified range or user-specified value by a predetermined amount. In some embodiments the system also includes a buffer vessel coupled to the feed vessel by a buffer supply line, and a diafiltration pump disposed in the buffer supply line for selectively delivering a buffer solution to the feed vessel. In some embodiments the diafiltration pump is coupled to the controller, the controller programmed to execute instructions for controlling operation of the diafiltration pump.

In some embodiments the system also includes a backpressure control valve disposed in the retentate line, the backpressure control valve for controlling for transmembrane pressure of the filter membrane. In some embodiments the system also includes pressure sensors in the feed line, the retentate line, and the permeate line, for measuring feed, retentate, and permeate pressures, respectively and for determining said transmembrane pressure.

A method for filtering a solution is disclosed. The method includes delivering a solution containing a target biomolecule from a feed vessel to a filter membrane; returning a retentate portion of said solution to the feed vessel, and delivering a permeate portion of said solution to a permeate vessel; determining, in real time using a variable pathlength instrument, a concentration of the target biomolecule in the solution; comparing the determined concentration of the target biomolecule is within a predetermined range of a user-defined concentration value, and based on the comparison, performing at least one of: continuing to deliver the solution to the filter membrane, adding a buffer solution to the feed vessel, providing an alert to a user, and stopping the method.

In some embodiments the filter membrane is a tangential flow filtration (TFF) membrane. In some embodiments the TFF membrane is a TFF hollow fiber filter membrane or a TFF cassette membrane.

In some embodiments the step of filtering the solution comprises a diafiltration method. In some embodiments the method also includes receiving, at a user interface, a diafiltration volume, a diafiltration concentration of the target biomolecule in the solution, and a final concentration of the target biomolecule in the solution. In some embodiments the step of delivering a solution comprises starting, by the computer, a diafiltration process by delivering the solution to the filtration membrane. In some embodiments the method also includes performing a diafiltration process until a user-selected diafiltration volume has been achieved.

In some embodiments the method also includes adding a buffer solution to the feed vessel to maintain a user-selected diafiltration concentration constant during the diafiltration process. In some embodiments the diafiltration volume is determined using information from a permeate scale associated with the permeate vessel. In some embodiments when the user-selected diafiltration volume has been achieved, the buffer solution is no longer provided to the feed vessel so that a concentration of the target biomolecule in the solution increases. In some embodiments when the concentration of the target biomolecule in the solution reaches a user-selected final concentration, a recirculation mode is initiated to maintain the retentate portion at a constant concentration.

### BRIEF DESCRIPTION OF THE DRAWINGS

The accompanying drawings illustrate preferred embodiments of the disclosed method so far devised for the practical application of the principles thereof, and in which:

FIG. 1 is a schematic view of an example embodiment of the disclosed system;

FIG. 2 is flowchart illustrating an example embodiment of a method of using the system of FIG. 1.

FIG. 3 is a comparison overlay of two ultrafiltration/diafiltration runs including a standard run using mass calculation and scale readings to determine target compound concentration, and an automated run using the system of FIG. 1.

It should be understood that the drawings are not necessarily to scale and that the disclosed embodiments are often illustrated diagrammatically and in partial views. In certain instances, details which are not necessary for an understanding of the disclosed methods and devices, or which render other details difficult to perceive may have been omitted.

### DESCRIPTION OF EMBODIMENTS

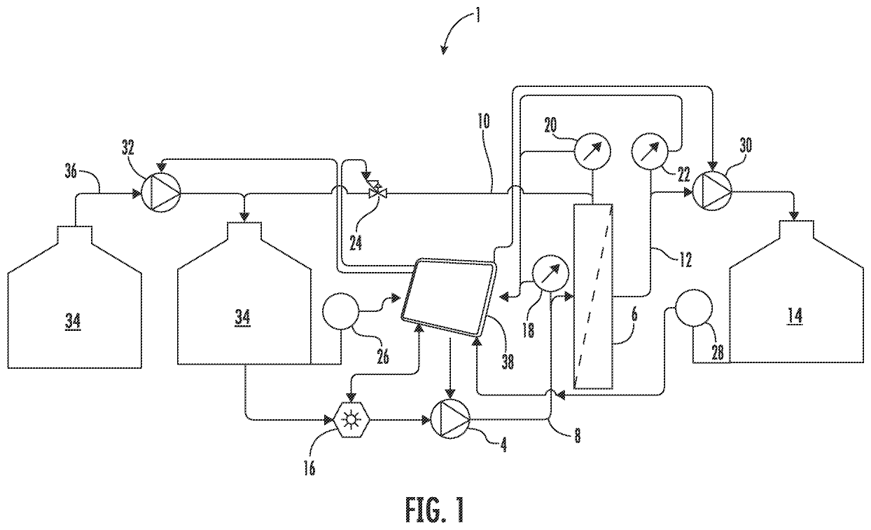

FIG. 1 illustrates an exemplary system 1 according to the present disclosure. The system 1 may be a TFF recirculation loop including a feed tank 2 containing a cell culture mixture (feedstock), a feed pump 4 for directing the feedstock through a TFF membrane 6 at a user determined flow rate via a feed line 8, a retentate line 10 for returning a retentate portion of the feedstock to the feed tank 2, and a permeate line 12 for directing a permeate portion of the feedstock to a permeate tank 14. A variable pathlength UV spectrophotometer 16 may be disposed in the feed line 8 for obtaining real time measurements representative of the concentration of a target biomolecule in the feedstock. In one embodiment, the variable pathlength UV spectrophotometer 16 may be a C-Tech FlowVPX System offered by Repligen Corporation. The variable pathlength UV spectrophotometer 16 may in some embodiments be capable of making spectral and fixed-point measurements at wavelengths between 190 nm and 1100 nm at pathlengths between 5 microns and 8 millimeters.

Pressure sensors 18, 20, 22 may be provided in the feed line 8, the retentate line 10 and the permeate line 12, for measuring feed, retentate, and permeate pressures, respectively. Pressures obtained via these pressure sensors 18, 20, 22 may be used to determine transmembrane pressure (TMP). A backpressure control valve 24 may be disposed in the retentate line 10 to control TMP by adjusting back pressure on the retentate line as desired.

A feed scale 26 may be provided to monitor feed concentration factor by monitoring the weight of the feed tank and its contents during diafiltration. Data from the feed scale 26 and the variable pathlength UV spectrophotometer 16 may be used to monitor feed concentration progress towards a desired concentration factor. Data from the feed scale 26 and the variable pathlength UV photometer 16 may also, or alternatively, be used to monitor and maintain a targeted feed concentration during diafiltration. A permeate scale 28 may be provided to monitor an amount (weight) of permeate collected in the permeate tank 14. Data from the permeate scale 28 can be used to calculate the number of diavolumes during diafiltration or to calculate a concentration factor.

A permeate pump 30 can be disposed in the permeate line 12 and can be used to control a rate of filtration and also to stop filtration on the permeate line. A permeate shut off valve (not shown) can be disposed in the permeate line 12 to stop filtration by closing the permeate line. It will be appreciated that the permeate pump 30 is optional and thus in sum embodiments the system 1 may not include a permeate pump (or if a permeate pump is provided it can be selectively employed during operation of the system). As will be appreciated, one purpose of the permeate pump 30 is to control the rate of flux across the filter membrane 6, however, in many processes is desirable to simply allow filtration to occur at a natural rate it (i.e., the rate at which it would occur without a pump slowing it down if it would naturally run faster, or speeding it up by pulling permeate through the filter membrane 6).

A diafiltration pump 32 can be provided for processes which include diafiltration/buffer exchange. The diafiltration pump 32 can be used to add buffer from a buffer tank 34 to the feed tank 2 via a buffer supply line 36. The diafiltration pump 32 can be used to maintain a constant protein concentration in the feed tank by replacing feed stock that permeates through the filter during a diafiltration process.

The system 1 may include a computer 38 including a processor running automation software programmed to control a variety of aspects of the system. The computer 38 may include memory which can include, but is not limited to, electronic, optical, magnetic, or any other storage or transmission device capable of providing a processor, ASIC, FPGA, etc. with program instructions. The memory may include a memory chip, Electrically Erasable Programmable Read-Only Memory (EEPROM), erasable programmable read only memory (EPROM), flash memory, or any other suitable memory from which the controller can read instructions. The instructions may include code from any suitable programming language.

The computer 38 may be coupled to any and/or all of the system components to receive input data from those components and to control operation of systems pumps and/or valves and to adjust other system parameters based on the received input data. The computer 38 may be coupled to the variable pathlength UV spectrophotometer 16 to receive real-time data representative of the concentration of a target biomolecule in the feedstock. In embodiments, the processor of the computer 38 may execute instructions (e.g., a subroutine) to obtain data from one or more of the components of the system 1, determine system parameters (e.g., target biomolecule concentrations), and control one or more of the components to adjust TFF system operating parameters.

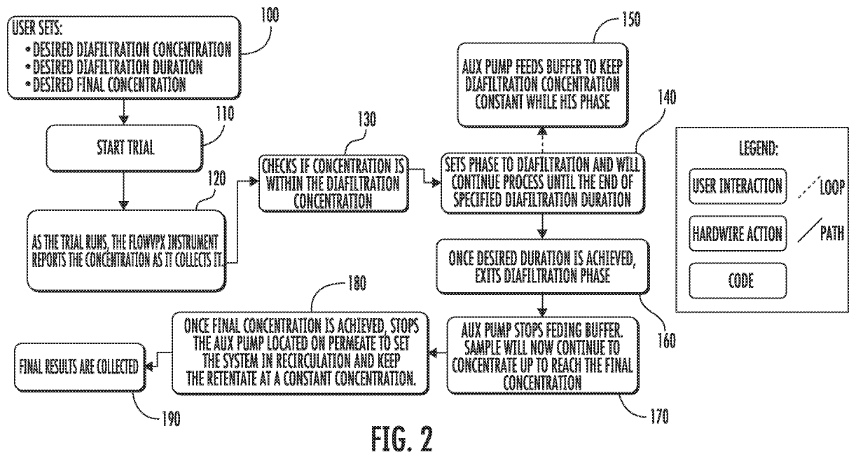

FIG. 2 is a flowchart illustrating an exemplary process flow implementing the system of FIG. 1. At step 100, a user sets a desired initial concentration endpoint of a target biomolecule in a feedstock, a desired diafiltration volume, and a desired final concentration endpoint of the target biomolecule in the feedstock. This information can be input by the user to an appropriate graphical user interface (GUI) of the computer 38. At step 110, the process begins as commanded by the computer 38. The feed pump 4 and permeate pump 30 may be started at this step. At step 120 the variable pathlength UV spectrophotometer 16 senses a characteristic of the feedstock in the feedline 8 and sends data to the computer 38 representative of a concentration of the target biomolecule in the feedstock. At step 130, the computer 38 determines whether the received data indicates the concentration of the target biomolecule is within the user-selected diafiltration concentration and/or has achieved the desired initial concentration endpoint. If the determined concentration of the target biomolecule indicates that the initial concentration has not been reached, then the system will continue in its present mode. If the determined concentration of the target biomolecule indicates that the initial concentration has been reached (or exceeded) then, then at step 140, the computer 38 sets the system to a diafiltration phase. During the diafiltration phase, the feed pump 4 and the permeate pump 30 (if a permeate pump is used) may operate at the same speed. At step 150 the diafiltration pump 32 feeds buffer into the feed tank 2 to maintain the diafiltration concentration of the target biomolecule constant. In some embodiments the variable pathlength UV spectrophotometer 16 observes and reports data to the computer 38 indicating the constancy of the target biomolecule concentration during this phase. The diafiltration phase continues until the end of the user-selected diafiltration volume is determined (e.g., reaching a predetermined weight on permeate scale 28). When the desired diafiltration volume is achieved, at step 160 the system exits the diafiltration phase. In some embodiments diafiltration volume is measured using information from the permeate scale 28.

At step 170, the final concentration phase begins. The diafiltration pump 32 stops feeding buffer into the feed tank 2, and the feedstock continues to concentrate the target biomolecule to reach the user-selected final concentration of the target biomolecule in the feedstock. During this final concentration phase the variable pathlength UV spectrophotometer 16 senses a characteristic of the feedstock in the feedline 8 and sends data to the computer 38 representative of a concentration of the target biomolecule of the feedstock. If the determined concentration of the target biomolecule indicates that the final concentration has not been reached, then the system will continue in its present mode. If the determined concentration of the target biomolecule indicates that the final concentration has been reached (or exceeded), then at step 180, the permeate pump 30 is stopped. The system 1 then operates in a recirculation mode to keep the retentate at a constant concentration. The process is ended at step 190 where final results are collected and stored and/or provided in visual form to the user.

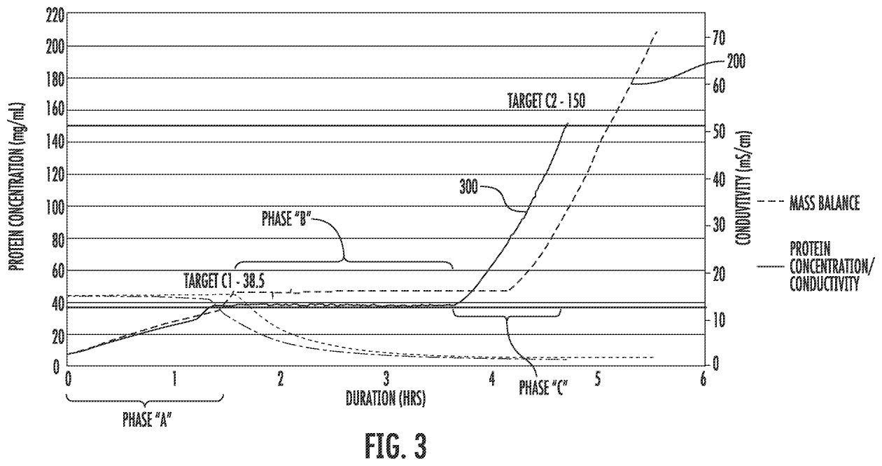

Referring now to FIG. 3, a plot is provided comparing a conventional manual concentration determination during an ultrafiltration/diafiltration process with concentration measurement using the disclosed system. The plot includes three phases. Phase “A” is a plot of target molecule concentration in the feedstock as initial concentration is increased. Phase “B” is a plot of target molecule concentration during diafiltration. In this phase, buffer is added to the feed tank 2 from the buffer tank 32 to maintain volume in the feed tank. Phase “C” is a final concentration building phase in which the target molecule concentration increases until the user specified final concentration is achieved. In this example the initial concentration endpoint (C1) is 38.5 milligrams per milliliter (mg/ml), while the final concentration endpoint (C2) is 150 mg/ml.

Conventional mass balance calculation values of concentration are shown in curve 200, while concentration values measured using the system 1 of FIG. 1 is shown in curve 300. As can be seen, the conventional mass balance technique results in overconcentration of the target biomolecule in the feedstock at both the initial concentration endpoint and the final concentration endpoint. Thus, with the convention mass balance a secondary dilution of the feedstock is required to achieve the final target concentration.

With the system 1 using constant concentration monitoring and control using the variable pathlength UV spectrophotometer 16, curve 300 is smoother and provides a more accurate determination of concentration values as compared to curve 200. Curve 300 also achieves a final user specified concentration (200 mg/ml) whereas curve 200 falls short of the final user specified concentration.

As will be appreciated, the ability to continuously monitor concentration of a target molecule in a feedstock enables fine control over the diafiltration process as compared to conventional methods. The system 1 can operate to adjust any of a variety of process parameters (e.g., through control of feed pump 4, permeate pump 30 and/or diafiltration pump 32) to maintain concentration within a desired band during various aspects of a diafiltration process. The system 1 can also include one or more alerts, warnings or other signals to a user when the system determines that the measured concentration of a target molecule in a feedstock is outside a user-specified range. In some embodiments the system 1 may stop one or more processes when the measured concentration of a target molecule in a feedstock is outside a user-specified range.

It will also be appreciated that continuous monitoring and system adjustment approach facilitated by the system 1 can be expanded to use in a variety of applications, such as controlling more than one diafiltration with multiple different buffers. In addition, diafiltration can be implemented in the disclosed system using cassette-based and/or hollow fiber filters.

While the present invention has been disclosed with reference to certain embodiments, numerous modifications, alterations and changes to the described embodiments are possible without departing from the spirit and scope of the invention, as defined in the appended claims. Accordingly, it is intended that the present invention not be limited to the described embodiments, but that it has the full scope defined by the language of the following claims, and equivalents thereof.

What is claimed is:

1. A system for filtration of a feedstock, the system comprising:
a feed vessel containing a solution comprising a target biomolecule;
a filter membrane coupled to the feed vessel via a feed line for receiving said solution and filtering said solution, the filter membrane further coupled to the feed vessel via a retentate line for returning filtered solution to the feed vessel;
a feed pump for moving the solution from the feed vessel to the filter membrane;
a permeate line coupled to the filter membrane, the permeate line for delivering permeate from the filter membrane to a permeate vessel;
a variable path-length instrument coupled to at least one of the feed line and the retentate line, the variable path-length instrument configured to transmit light through said solution in the feed line and to correlate, in realtime, the transmitted light with a concentration of the target biomolecule in the solution; and
a controller coupled to the variable path-length instrument and the feed pump to receive information therefrom and to execute instructions for controlling operation of at least one of the feed pump, the diafiltration pump, and the variable path-length instrument based on said received information.

2. The system of claim 1, wherein the controller is programmed to execute instructions for adjusting a speed of at least one of the diafiltration pump, to maintain the concentration of the target biomolecule in the solution within a predetermined range.

3. The system of claim 1, wherein the controller is programmed to execute instructions for adjusting a speed of the diafiltration pump during a diafiltration step, to maintain the concentration of the target biomolecule in the solution within a predetermined range.

4. The system of claim 1, wherein the controller is programmed to execute instructions for receiving, from a user, input values for target concentration and/or diafiltration volume for the system to perform a combination of concentration and diafiltration steps.

5. The system of claim 4, wherein the controller is programmed to execute instructions for periodically determining, based on information received from the variable path-length instrument, whether the concentration of the target biomolecule is within a predetermined range of the user input concentration.

6. The system of claim 4, wherein the controller is programmed to execute instructions for periodically determining, based on information received from the variable path-length instrument, whether the concentration of the target biomolecule is equal to the user input final concentration.

7. The system of claim 1, wherein the filter membrane is a tangential flow filtration (TFF) membrane.

8. The system of claim 7, wherein the TFF membrane is a TFF hollow fiber filter membrane or a TFF cassette membrane.

9. The system of claim 1, wherein the controller is configured to provide a user-alert if the concentration of the target biomolecule in the solution is determined, based on information provided by the variable path-length instrument, to have departed from a user-specified range or user-specified value by a predetermined amount.

10. The system of claim 1, further comprising a buffer vessel coupled to the feed vessel by a buffer supply line, and a diafiltration pump disposed in the buffer supply line for selectively delivering a buffer solution to the feed vessel.

11. The system of claim 10, wherein the diafiltration pump is coupled to the controller, the controller programmed to execute instructions for controlling operation of the diafiltration pump.

12. The system of claim 1, further comprising a backpressure control valve disposed in the retentate line, the backpressure control valve for controlling for transmembrane pressure of the filter membrane.

13. The system of claim 12, further comprising pressure sensors in the feed line, the retentate line, and the permeate line, for measuring feed, retentate, and permeate pressures, respectively and for determining said transmembrane pressure.

14. A method for filtering a solution, comprising:
delivering a solution containing a target biomolecule from a feed vessel to a filter membrane;
returning a retentate portion of said solution to the feed vessel, and delivering a permeate portion of said solution to a permeate vessel;
determining, in real time using a variable pathlength instrument, a concentration of the target biomolecule in the solution;
comparing the determined concentration of the target biomolecule is within a predetermined range of a user-defined concentration value, and
based on the comparison, performing at least one of: continuing to deliver the solution to the filter membrane, adding a buffer solution to the feed vessel, providing an alert to a user, and stopping the method.

15. The method of claim 14, wherein the filter membrane is a tangential flow filtration (TFF) membrane.

16. The method of claim 15, wherein the TFF membrane is a TFF hollow fiber filter membrane or a TFF cassette membrane.

17. The method of claim 14, wherein filtering the solution comprises a diafiltration method.

18. The method of claim 14, further comprising receiving, at a user interface, a diafiltration volume, a diafiltration concentration of the target biomolecule in the solution, and a final concentration of the target biomolecule in the solution.

19. The method of claim 14, wherein delivering a solution comprises starting, by the computer, a diafiltration process by delivering the solution to the filtration membrane.

20. The method of claim 14, further comprising performing a diafiltration process until a user-selected diafiltration volume has been achieved.

21. The method of claim 20, further comprising adding a buffer solution to the feed vessel to maintain a user-selected diafiltration concentration constant during the diafiltration process.

22. The method of claim 21, wherein the diafiltration volume is determined using information from a permeate scale associated with the permeate vessel.

23. The method of claim 21, wherein when the user-selected diafiltration volume has been achieved, the buffer solution is no longer provided to the feed vessel so that a concentration of the target biomolecule in the solution increases.

24. The method of claim 23, wherein when the concentration of the target biomolecule in the solution reaches a user-selected final concentration, a recirculation mode is initiated to maintain the retentate portion at a constant concentration.
